(19) United States
(12) Patent Application Publication
(10) Pub. No.: US 2023/0306666 A1
(43) Pub. Date: Sep. 28, 2023

(54) Sound Based Modification Of A Virtual Environment

(71) Applicant: Meta Platforms Technologies, LLC, Menlo Park, CA (US)

(72) Inventors: Christopher James Mitchell, Ely (GB); Neil Cooper, Ely (GB); Iain Dendle, Southampton (GB); Karol Artur Jaworski, Peterborough (GB); Angus Edward Stewart, Cambridge (GB)

(21) Appl. No.: 17/656,384

(22) Filed: Mar. 24, 2022

(51) Int. Cl. G06T 13/20; G10L 25/78; G10L 25/51

(52) U.S. Cl. CPC G06T 13/205; G10L 25/78; G10L 25/51

(57) ABSTRACT

A computing device for modifying a virtual environment based on a detected sound, the computing device comprising: a microphone; a display configured to display a virtual environment to a user; and a processor; wherein the processor is configured to: receive, via the microphone, audio data of audio in a monitored environment; use the audio data to determine the occurrence of a non-speech target sound in the monitored environment; determine a modification of the virtual environment associated with the non-speech target sound; and control the display to implement the determined modification.

### FIELD

The present disclosure generally relates to modifying a virtual environment based on a detected sound.

### BACKGROUND

Some background information on sound recognition systems and methods can be found in the applicant's PCT application WO2010/070314 and US application US 2021/0104230, both of which are hereby incorporated by reference in their entirety.

### SUMMARY

Example embodiments relate to the potential for new applications of sound recognition systems.

Technology exists for mapping speech/voice and facial movements to digital avatars used in visual media (computer games, VR/AR, video call applications, etc.). The inventors have identified that this experience and interaction can be enhanced through non-speech sound detection.

The inventors have recognised that in certain situations it is difficult for a user to interact with other users via their digital avatars or display elements displayed on the display of their device (e.g., when a user is walking or when a user is immersed in a virtual world). It can be difficult for users to gain an intuitive understanding of the emotions of other users that they are communicating with remotely. There is a particular risk of misunderstanding when users are communicating without being in the same physical space and are therefore unable to interpret e.g. body language or facial expressions.

Additionally, manually selecting display elements can be inconvenient for the user, especially if they are e.g. walking, and may cause the user to make incorrect or unintentional selections in a user interface displayed on the display of the computing device when the user wants to express their emotions or current state, and the processor on the computing device must incur unnecessary processor resources processing these inputs.

Embodiments of the present disclosure improve the user experience by simplifying the modification of a virtual environment by modifying the virtual environment based on non-speech sound detection.

According to one aspect of the present disclosure there is provided a computing device for modifying a virtual environment based on a detected sound, the computing device comprising: a microphone; a display configured to display a virtual environment to a user; and a processor; wherein the processor is configured to: receive, via the microphone, audio data of audio in a monitored environment; use the audio data to determine the occurrence of a non-speech target sound in the monitored environment; determine a modification of the virtual environment associated with the non-speech target sound; and control the display to implement the determined modification.

The computing device may further comprise a user input device, wherein the virtual environment comprises a virtual scene and a user controlled object positioned within the virtual scene, the user controlled object controllable by the user using the user input device.

The determined modification may comprise a modification of the virtual scene.

The determined modification may comprise a modification of a lighting level of the virtual scene.

The determined modification may comprise a modification of the appearance of scenery of the virtual scene.

The determined modification may comprise insertion of at least one new virtual object into the virtual scene.

The determined modification may comprise a modification of the user controlled object.

The determined modification may comprise at least one of a modification of an expression of the user controlled object, a modification of a colour of the user controlled object, a visual animation of the user controlled object, and adding a new object to the user controlled object

The user controlled object may be an avatar.

The processor may be further configured to generate metadata relating to the non-speech target sound, and determine the modification based on the metadata.

The metadata may comprise labels describing at least one of an intensity of the non-speech target sound, a temporal pattern of the non-speech target sound, a count of a number of occurrences of the non-speech target sound, and a duration of the non-speech target sound.

The metadata may comprise quantitative measurements of an intensity of the non-speech target sound, a temporal pattern of the non-speech target sound, a count of a number of occurrences of the non-speech target sound, and a duration of the non-speech target sound.

The at least one target sound may convey semantic information.

The virtual environment may be an electronic video game environment.

The virtual environment may be part of a metaverse virtual world.

The display may be a virtual reality display or an augmented reality device.

The computing device may further comprise a memory storing one or more sound models, wherein the sound models correspond to one or more non-speech target sounds; and the processor may be configured to determine the occurrence of a non-speech target sound in the monitored environment by comparing the audio data to said one or more sound models to recognize a non-speech target sound of said one or more non-speech target sounds in the monitored environment.

Each of the one or more sound models may correspond to a respective non-speech target sound.

According to another aspect of the present disclosure there is provided a method of modifying a virtual environment based on a detected sound, the method implemented on a processor contained in a computing device and comprising: displaying a virtual environment to a user using a display; receiving audio data of audio in a monitored environment using a microphone; using the audio data to determine the occurrence of a non-speech target sound in the monitored environment; determining a modification of the virtual environment associated with the non-speech target sound; and controlling the display to implement the determined modification.

According to another aspect of the present disclosure there is provided a computer-readable storage medium comprising instructions which, when executed by a processor of a computing device cause the computing device to perform the methods described herein.

It will be appreciated that the functionality of the devices we describe may be divided across several modules. Alternatively, the functionality may be provided in a single module or a processor. The or each processor may be implemented in any known suitable hardware such as a microprocessor, a Digital Signal Processing (DSP) chip, an Application Specific Integrated Circuit (ASIC), Field Programmable Gate Arrays (FPGAs), etc. The, or each processor may include one or more processing cores with each core configured to perform independently. The, or each processor may have connectivity to a bus to execute instructions and process information stored in, for example, a memory.

The invention further provides processor control code to implement the above-described systems and methods, for example on a general purpose computer system or on a digital signal processor (DSP). The invention also provides a carrier carrying processor control code to, when running, implement any of the above methods, in particular on a non-transitory data carrier—such as a disk, microprocessor, CD- or DVD-ROM, programmed memory such as read-only memory (Firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (Firmware). Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate such code and/or data may be distributed between a plurality of coupled components in communication with one another. The invention may comprise a controller which includes a microprocessor, working memory and program memory coupled to one or more of the components of the system.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 shows a block diagram of a computing device;

FIG. 2 illustrates an example virtual environment;

FIG. 3 is a flow chart illustrating a process to modify a virtual environment based on a detected sound;

FIG. 4 illustrates modification of a user controlled object in a virtual environment based on a detected sound;

FIGS. 5 and 6 illustrates insertion of a virtual object into a virtual scene of a virtual environment based on a detected sound; and

FIG. 7 illustrates modification of the appearance of scenery of a virtual scene of a virtual environment based on a detected sound.

### DETAILED DESCRIPTION

Embodiments will now be described by way of example only.

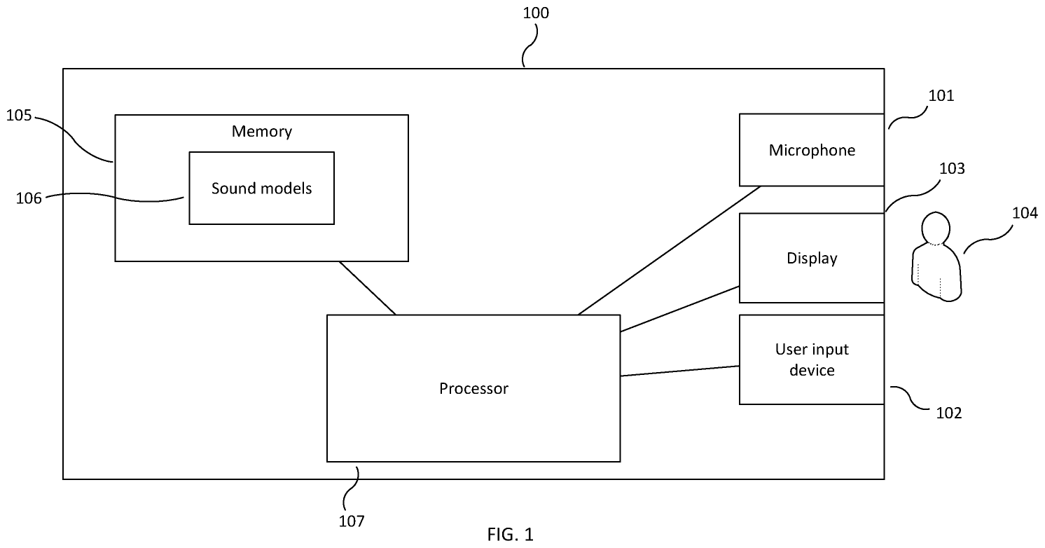

FIG. 1 shows a computing device 100 in a monitored environment which may be an indoor space (e.g. a house, a gym, a shop, a railway station etc.), an outdoor space or in a vehicle. The computing device 100 is associated with a user 104.

It will be appreciated from the below that FIG. 1 is merely illustrative and the computing device 100 of embodiments of the present disclosure may not comprise all of the components shown in FIG. 1.

The computing device 100 may be a PC, a mobile computing device such as a laptop, smartphone, tablet-PC, a virtual reality (VR) headset, a set of augmented reality (AR) glasses, a consumer electronics device (e.g. a TV), or other electronics device (e.g. an in-vehicle device). The computing device 100 may be a mobile device such that the user 104 can move the computing device 100 around the monitored environment. Alternatively, the computing device 100 may be fixed at a location in the monitored environment (e.g. a panel mounted to a wall of a home). Alternatively, the device may be worn by the user by attachment to or sitting on a body part or by attachment to a piece of garment.

The computing device 100 comprises a processor 107 coupled to memory 105.

The functionality of the processor 107 described herein may be implemented in code (software) stored on a memory (e.g. memory 105) comprising one or more storage media, and arranged for execution on a processor comprising one or more processing units. The storage media may be integrated into and/or separate from the processor 107. The code is configured so as when fetched from the memory and executed on the processor to perform operations in line with embodiments discussed herein. Alternatively, it is not excluded that some or all of the functionality of the processor 107 is implemented in dedicated hardware circuitry (e.g. ASIC(s), simple circuits, gates, logic, and/or configurable hardware circuitry like an FPGA).

The computing device 100 comprises a microphone 101. The microphone 101 is configured to sense audio in a monitored environment of the computing device 100 and supply audio data to the processor 107. The microphone 101 may be external to the computing device 100 and be coupled to the computing device 100 by way of a wired or wireless connection.

The computing device 100 comprises one or more user input device 102 e.g. a keypad, keyboard, mouse, joystick, game console controller, and/or a virtual reality controller. The user input device(s) 102 allow the user 104 to supply user inputs to the processor 107. One or more of the user input device(s) 102 may be external to the computing device 100 and be coupled to the computing device 100 by way of a wired or wireless connection.

The computing device 100 comprises a display 103 for outputting image data. It will be appreciated that the display 103 may be a touch sensitive display and thus act as an input device. In some embodiments, the display 103 is a VR display. The display 103 may be external to the computing device 100 and be coupled to the computing device 100 by way of a wired or wireless connection.

The processor 107 is configured to recognise a non-speech target sound using the audio data received from the microphone 101. In some embodiments, the processor 107 is configured to recognise a non-speech target sound by comparing the audio data to one or more sound models 106 stored in the memory 105. The sound model(s) may be associated with one or more target sounds (which may be for example, a laugh, a sound indicating anger, a growl, a clap, and a finger snapping).

As shown in FIG. 1, the computing device 100 may store the sound models locally (in memory 105) and so does not need to be in constant communication with any remote system in order to identify a captured sound. Alternatively, the storage of the sound model(s) 106 is on a remote server (not shown in FIG. 1) coupled to the computing device 100, and sound recognition software on the remote server is used to perform the processing of audio received from the computing device 100 to recognise that a sound captured by the computing device 100 corresponds to a non-speech target sound. In these embodiments, the computing device 100 transmits the audio data to the remote server for processing, and receives an indication of the non-speech target sound. This advantageously reduces the processing performed on the computing device 100.

Further information on the sound model(s) 106 is provided below.

A sound model associated with a target sound is generated based on processing a captured sound corresponding to the target sound class. Preferably, multiple instances of the same sound are captured more than once in order to improve the reliability of the sound model generated of the captured sound class.

In order to generate a sound model the captured sound class(es) are processed and parameters are generated for the specific captured sound class. The generated sound model comprises these generated parameters and other data which can be used to characterise the captured sound class.

There are a number of ways a sound model associated with a target sound class can be generated. The sound model for a captured sound may be generated using machine learning techniques or predictive modelling techniques such as: hidden Markov model, neural networks, support vector machine (SVM), decision tree learning, etc.

The applicant's PCT application WO2010/070314, which is incorporated by reference in its entirety, describes in detail various methods to identify sounds. Further methods are also described in the applicant's US application US 2021/0104230, which is also incorporated by reference in its entirety. The skilled person would appreciate that various methods of sound identification based on machine learning exist and can be implemented for performing the sound detection described herein. In the following we describe one particular method merely by way of example.

Broadly speaking an input sample sound is processed by decomposition into frequency bands, and optionally de-correlated, for example, using PCA/ICA, and then this data is compared to one or more Markov models to generate log likelihood ratio (LLR) data for the input sound to be identified. A (hard) confidence threshold may then be employed to determine whether or not a sound has been identified; if a “fit” is detected to two or more stored Markov models then preferably the system picks the most probable. A sound is “fitted” to a model by effectively comparing the sound to be identified with expected frequency domain data predicted by the Markov model. False positives are reduced by correcting/updating means and variances in the model based on interference (which includes background) noise.

It will be appreciated that other techniques than those described herein may be employed to create a sound model.

The sound recognition system may work with compressed audio or uncompressed audio. For example, the time-frequency matrix for a 44.1 KHz signal might be a 1024 point FFT with a 512 overlap. This is approximately a 20 milliseconds window with 10 millisecond overlap. The resulting 512 frequency bins are then grouped into sub bands, or example quarter-octave ranging between 62.5 to 8000 Hz giving 30 sub-bands.

A lookup table can be used to map from the compressed or uncompressed frequency bands to the new sub-band representation bands. For the sample rate and STFT size example given the array might comprise of a (Bin size÷2)×6 array for each sampling-rate/bin number pair supported. The rows correspond to the bin number (centre)—STFT size or number of frequency coefficients. The first two columns determine the lower and upper quarter octave bin index numbers. The following four columns determine the proportion of the bins magnitude that should be placed in the corresponding quarter octave bin starting from the lower quarter octave defined in the first column to the upper quarter octave bin defined in the second column. e.g. if the bin overlaps two quarter octave ranges the 3 and 4 columns will have proportional values that sum to 1 and the 5 and 6 columns will have zeros. If a bin overlaps more than one sub-band more columns will have proportional magnitude values. This example models the critical bands in the human auditory system. This reduced time/frequency representation is then processed by the normalisation method outlined. This process is repeated for all frames incrementally moving the frame position by a hop size of 10 ms. The overlapping window (hop size not equal to window size) improves the time-resolution of the system. This is taken as an adequate representation of the frequencies of the signal which can be used to summarise the perceptual characteristics of the sound. The normalisation stage then takes each frame in the sub-band decomposition and divides by the square root of the average power in each sub-band. The average is calculated as the total power in all frequency bands divided by the number of frequency bands. This normalised time frequency matrix is the passed to the next section of the system where a sound recognition model and its parameters can be generated to fully characterise the sound's frequency distribution and temporal trends.

The next stage of the sound characterisation requires further definitions.

A machine learning model is used to define and obtain the trainable parameters needed to recognise sounds. Such a model is defined by:
a set of trainable parameters θ, for example, but not limited to, means, variances and transitions for a hidden Markov model (HMM), support vectors for a support vector machine (SVM), weights, biases and activation functions for a deep neural network (DNN),
a data set with audio observations o and associated sound labels l, for example a set of audio recordings which capture a set of target sounds of interest for recognition such as, e.g., baby cries, dog barks or smoke alarms, as well as other background sounds which are not the target sounds to be recognised and which may be adversely recognised as the target sounds. This data set of audio observations is associated with a set of labels l which indicate the locations of the target sounds of interest, for example the times and durations where the baby cry sounds are happening amongst the audio observations o.

Generating the model parameters is a matter of defining and minimising a loss function L(θ|o,l) across the set of audio observations, where the minimisation is performed by means of a training method, for example, but not limited to, the Baum-Welsh algorithm for HMMs, soft margin minimisation for SVMs or stochastic gradient descent for DNNs.

To classify new sounds, an inference algorithm uses the model to determine a probability or a score P(C|o,θ) that new incoming audio observations o are affiliated with one or several sound classes C according to the model and its parameters θ. Then the probabilities or scores are transformed into discrete sound class symbols by a decision method such as, for example but not limited to, thresholding or dynamic programming.

The models will operate in many different acoustic conditions and as it is practically restrictive to present examples that are representative of all the acoustic conditions the system will come in contact with, internal adjustment of the models will be performed to enable the system to operate in all these different acoustic conditions. Many different methods can be used for this update. For example, the method may comprise taking an average value for the sub-bands, e.g. the quarter octave frequency values for the last T number of seconds. These averages are added to the model values to update the internal model of the sound in that acoustic environment.

In embodiments whereby the computing device 100 performs audio processing to recognise a target sound in the monitored environment, this audio processing comprises the microphone 101 of the computing device 100 capturing a sound, and the processor 107 analysing this captured sound. In particular, the processor 107 compares the captured sound to the one or more sound models 106 stored in memory 105. If the captured sound matches with the stored sound models, then the sound is identified as the target sound.

Embodiments of the present disclosure relate to modifying a virtual environment based on non-speech sound detection.

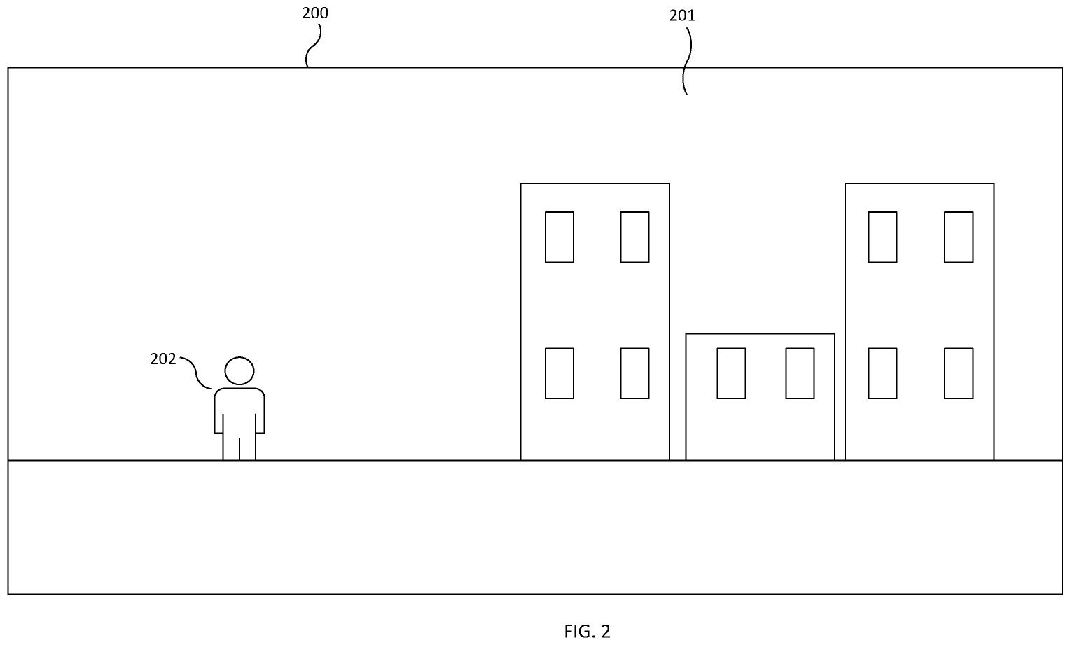

FIG. 2 illustrates an example virtual environment 200 which is displayed to the user 104 on the display 103. The virtual environment 200 comprises a virtual scene 201 and a user controlled object 202 positioned within the virtual scene 201.

The user 104 is able to control the user controlled object 202 using a user input device 102. For example, the user may be able to move the user controlled object 202, make the user controlled object 202 perform an action, interact with the virtual scene 201, interact with other user controlled objects controlled by other users etc.

As shown in FIG. 2, the user controlled object 202 may be an avatar which represents the user 104 in the virtual environment. We refer herein to an avatar being a human-like representation of the user 104 (e.g. a user controlled character). Typically, a user may customize their avatar in variety of ways dealing with appearance, such as facial features and clothing. This allows the user a more personalized and involved experience within the virtual environment.

It will be appreciated that embodiments of the present disclosure are not limited to the user controlled object 202 being an avatar, and embodiments extend to any object avatar which represents the user 104 in the virtual environment. For example, the user controlled object 202 may be an animal, a vehicle (e.g. a car), a computer game character, a plant, or a geometric shape (e.g. a sphere) etc. It will be appreciated that these are merely examples and not an exhaustive list. The user controlled object 202 may be a two-dimensional or a three-dimensional object.

The virtual environment 200 may be any three-dimensional virtual space.

In one example the virtual environment 200 may be an electronic video game environment with the virtual scene 201 comprising scenery of the electronic video game. For example, the user controlled object 202 may be a car in a car-racing video game.

In another example, the virtual environment 200 may be part of a “metaverse” with the virtual scene 201 comprising scenery associated with a particular location in the metaverse. We refer herein to a “metaverse” to include one or more online virtual environments which are accessible to one or more users/players. Access to a metaverse is not limited to the use of a VR headset and can be accessed via any user input device 102 (for example screens or AR glasses) and displayed on the display 103.

If viewed via AR glasses, one or more portions of the real world may be displayed to the user alongside the virtual environment.

The metaverse may be used for social interaction, allowing users to have friends, create groups, talk and mingle with other users, and move to different locations within the metaverse.

The metaverse may be used for online learning, for example the user controlled object 202 may be an avatar which can be controlled to access virtual lecture theatres or classrooms to attend online learning sessions.

The metaverse may be used for recreation, for example the user controlled object 202 may be an avatar which can be controlled to play an online poker game, with the virtual scene 201 comprising scenery associated with a casino.

The metaverse may provide a virtual workplace, for example the user controlled object 202 may be an avatar which can be controlled to access different rooms of a virtual workplace to enable the user 104 to speak to other users in the virtual workplace and collaborate on different work projects.

The metaverse may provide a virtual retail environment, for example the user controlled object 202 may be an avatar which can be controlled to access one or more car showrooms to enable the user 104 to view virtual representations of different cars and speak to salespersons themselves represented by avatars in the virtual retail environment.

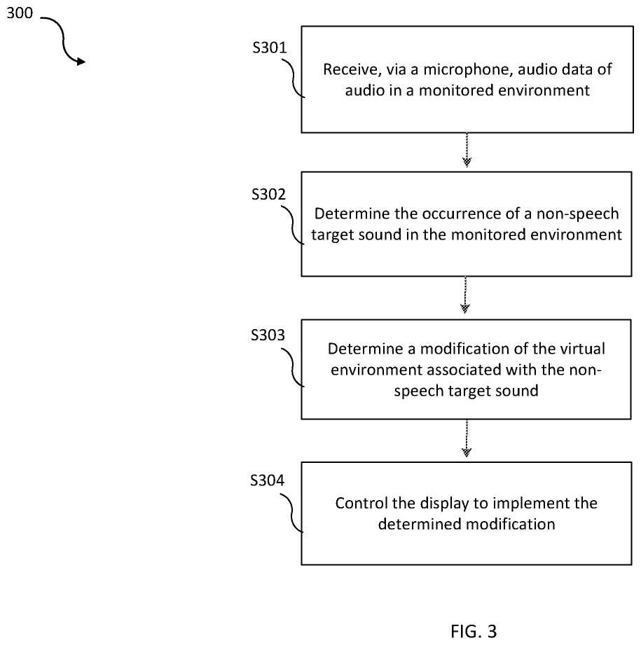

Reference is now made to FIG. 3 which is a flow chart illustrating a method 300 to modify a virtual environment based on a detected sound. The method 300 is performed by the processor 107.

At step S301, the processor 107 receives audio data of audio in the monitored environment, from the microphone 101.

At step S302, the processor 107 uses the received audio data to determine the occurrence of a non-speech target sound in the monitored environment.

At step S302, the processor 107 may process the received audio data to determine the occurrence of a non-speech target sound in the monitored environment. For example, the processor 107 may compare the audio data to one or more sound models 106 stored in memory 105 and determine the occurrence of a non-speech target sound based on the audio data matching with one of the sound models 106. The sound model(s) may be associated with one or more non-speech target sounds. Each of the one or more sound models 106 may correspond to a respective non-speech target sound.

Alternatively, at step S302 the processor 107 may transmit the audio data to the remote server for processing, and determine the occurrence of a non-speech target sound in the monitored environment based on receiving a message from the remote server. The remote server may store the sound model(s) 106, and be configured to compare the audio data to the one or more sound models 106 to determine the occurrence of a non-speech target sound based on the audio data matching with one of the sound models 106.

A non-speech target sound may be a verbal sound i.e. a sound generated by human vocal cords (e.g. of the user 104 or another user in the monitored environment). Examples of verbal non-speech target sounds include a laugh, a sound indicating anger, a growl, a shout, sigh etc.

A non-speech target sound may be a non-verbal sound i.e. a sound that is not generated by human vocal cords. Examples of non-verbal non-speech target sounds include: a finger snap/click, a hand clap, the sound of a pet animal vocalising.

Generally, a non-speech target sound conveys semantic information. That is, the non-speech target sound conveys meaning of particular interest to the user 104 rather than being merely background noise.

At step S303, the processor 107 determines a modification of the virtual environment that is associated with the non-speech target sound. In particular, the memory 105 may store a modification associated with each of one or more non-speech target sounds. Thus, at step S303 the processor 107 may query the memory 105 with the non-speech target sound to determine the modification associated with the non-speech target sound.

At step S304, the processor 107 controls the display 103 to implement the determined modification.

Step S304 may comprise the processor 107 implementing a modification of the user controlled object 202 in a virtual environment based on the non-speech target sound.

Modification of the user controlled object 202 may be implemented in a number of different ways.

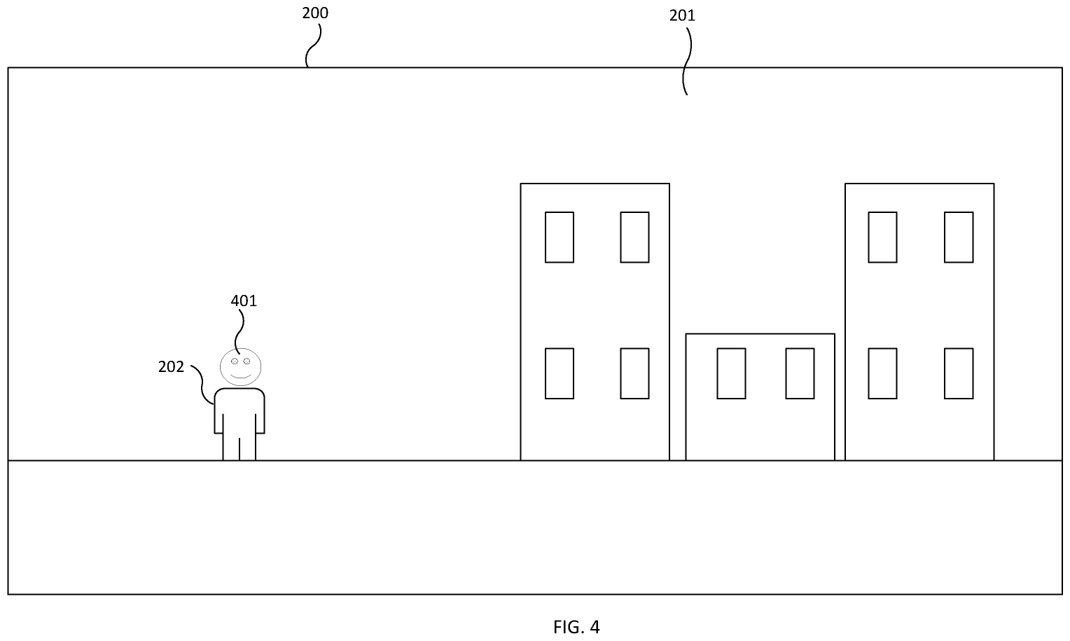

Modification of the user controlled object 202 may comprise a modification of an expression of the user controlled object 202. For example, in the context of the user controlled object 202 being an avatar, step S304 may comprise modification of a facial expression 404 of the avatar. This is illustrated in FIG. 4.

Alternatively or additionally, modification of the user controlled object 202 may comprise modification of a colour of the user controlled object 202. For example, in response to detecting a sound indicating anger, step S304 may comprise the processor 107 modifying the colour of the face of an avatar to turn red.

Alternatively or additionally, modification of the user controlled object 202 may comprise a visual animation of the user controlled object 202. For example, in response to detecting a laugh, step S304 may comprise the processor 107 to control the user controlled object 202 to perform a laughing action.

Alternatively or additionally, modification of the user controlled object 202 may comprise the addition of a new virtual object to the user controlled object. For example, in the context of the user controlled object 202 being an avatar, the new virtual object may comprise an item of clothing, or other such accessory.

In addition to or as an alternative to modification of the user controlled object 202, step S304 may comprise a modification of the virtual scene 201.

Modification of the virtual scene 201 may be implemented in a number of different ways.

Modification of the virtual scene 201 may comprise modification of a lighting level of the virtual scene 201. For example, in response to detecting a laugh, step S304 may comprise the processor 107 implementing a bright digital lighting level of the virtual scene 201, whereas in response to detecting a sound indicating anger, step S304 may comprise the processor 107 implementing a dark digital lighting level of the virtual scene 201.

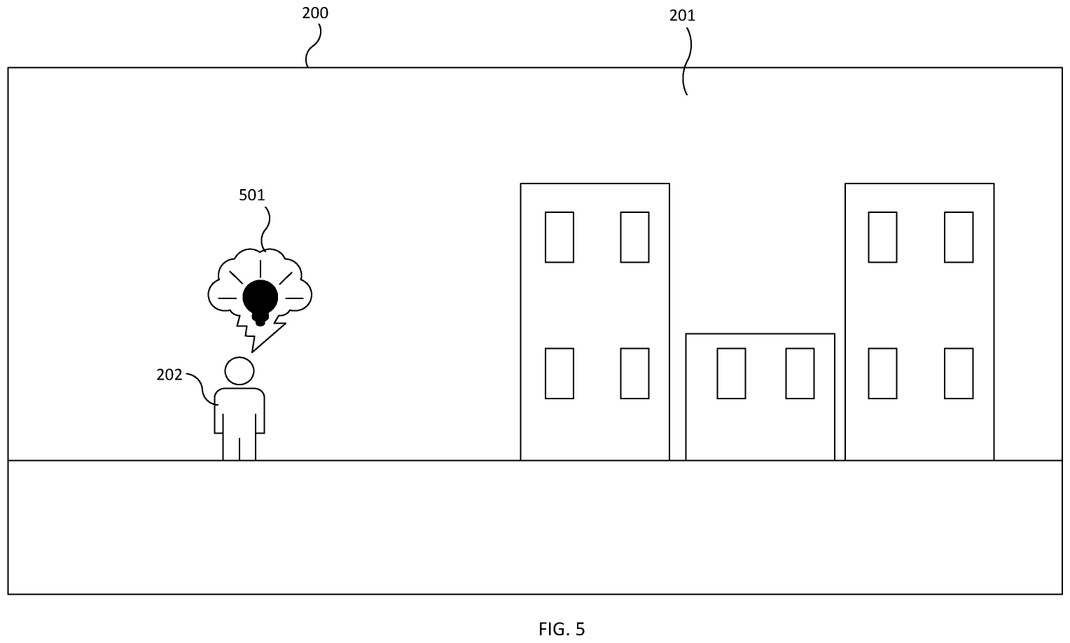

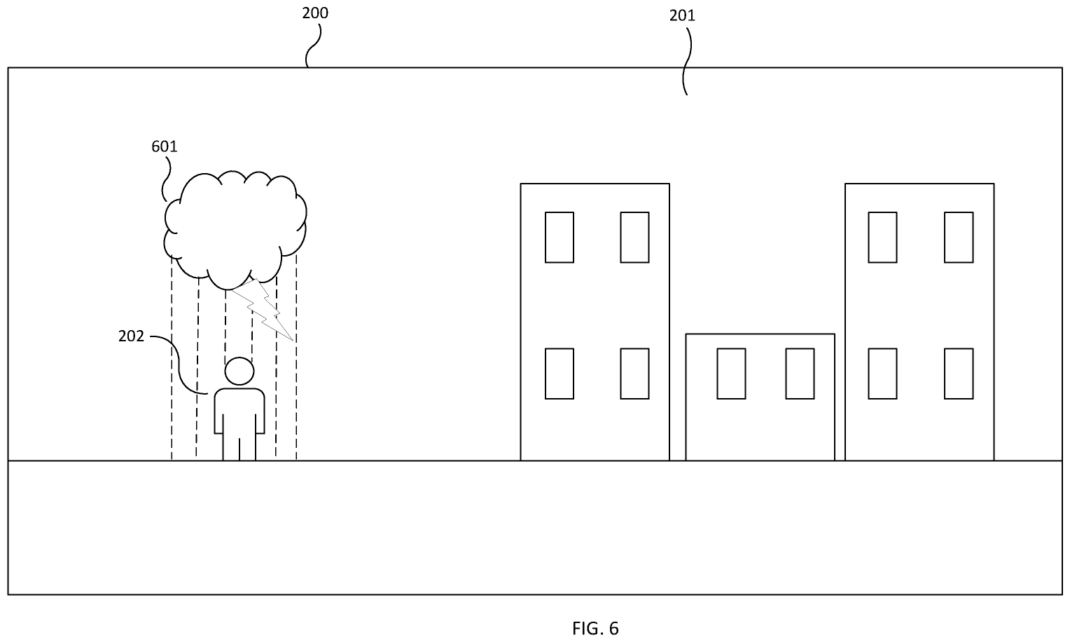

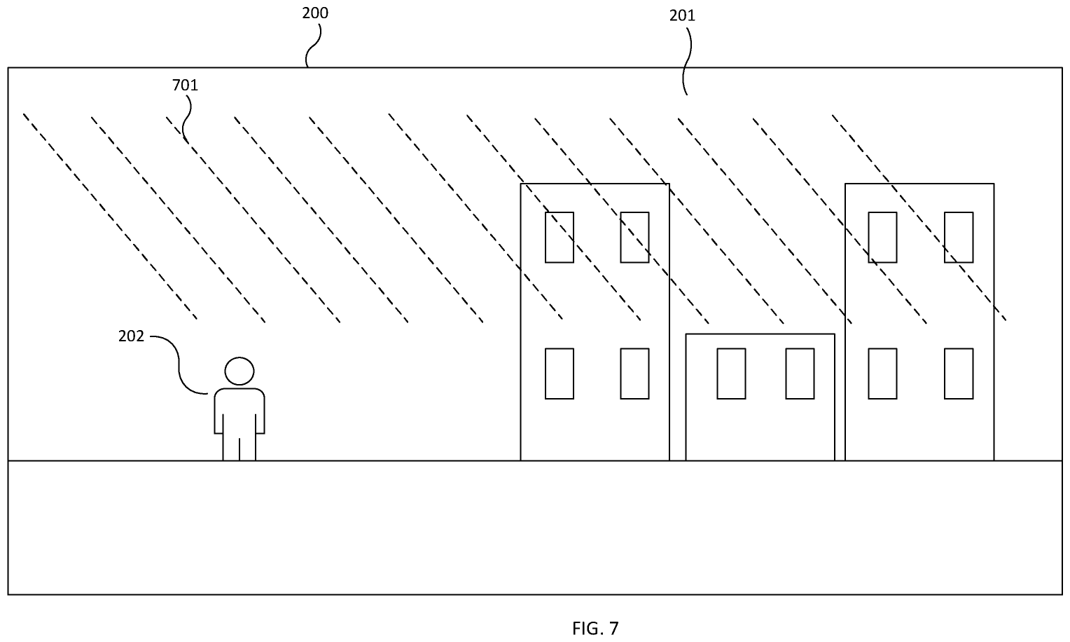

Alternatively or additionally, modification of the virtual scene 201 may comprise the insertion of at least one new virtual object into the virtual scene 201. We refer to the virtual object being “new” in that it was not displayed in the virtual scene 201 prior to the detection of the non-speech target sound. For example, in the context of the user controlled object 202 being an avatar, in response to detecting a finger snap/click, step S304 may comprise the processor 107 inserting a new virtual object 501 in the form of an image of a lightbulb, or a lightbulb turning on, above the avatar's head, this is illustrated in FIG. 5. In another example, in response to detecting a sound indicating anger, step S304 may comprise the processor 107 inserting a new virtual object 601 in the form of an image of a storm cloud, or an animated storm cloud, above the avatar's head, this is illustrated in FIG. 6. It will be appreciated that these are merely examples, and the new virtual object can take many different forms. In another example the new virtual object is an emoticon associated with the non-speech target sound. The new virtual object may be a two-dimensional or a 3-dimensional object. The new virtual object may be a static object or an animated object. The new virtual object may be inserted into the virtual scene 201 in the vicinity of the user controlled object 202 to convey the association of the new virtual object with the user controlled object 202. For example, the new virtual object may be inserted into the virtual scene 201 adjacent to, above or below the user controlled object 202.

Alternatively or additionally, modification of the virtual scene 201 may comprise modification of the appearance of scenery of the virtual scene 201. This modification may comprise adding or modifying a weather effects, for example in response to detecting a sound indicating anger, step S304 may comprise the processor 107 modifying the scenery of the virtual scene 201 by adding a raining weather effect. Furthermore, this modification may comprise modifying scenery displayed in the virtual scene 201 prior to the detection of the non-speech target sound. For example, in response to detecting a sound indicating anger, step S304 may comprise the processor 107 modifying windows of buildings to appear broken.

In any of the embodiments described above, the processor 107 may be further configured to generate metadata relating to the non-speech target sound, and determine the modification at step S303 based on the metadata in addition to the type of non-speech target sound.

The metadata may comprise qualitative labels describing at least one of an intensity of the non-speech target sound, a temporal pattern of the non-speech target sound, a count of a number of occurrences of the non-speech target sound, and a duration of the recognized non-speech target sound.

Alternatively the metadata may comprise quantitative measurements of an intensity of the non-speech target sound, a temporal pattern of the non-speech target sound, a count of a number of occurrences of the non-speech target sound, and a duration of the recognized non-speech target sound.

This metadata can be used by the processor 107 to elicit different modifications of the virtual environment. In one example, a snigger sound and a belly laugh sound may elicit different visual reactions in the user controlled object 202. In another example, a single clap may result in the processor 107 controlling the user controlled object 202 to make a sarcastic reaction, whereas sustained clapping may result in the processor 107 controlling the user controlled object 202 to make a cheering reaction. In yet another example, a single frustrated noise may result in the processor 107 controlling an avatar to have an angry face, whereas a continuous frustrated noise (e.g. a continued “grrr” sound) may result in the processor 107 inserting a new virtual object (in the form of a growing thunder cloud) into the virtual scene 201 above the avatar's head.

Thus, it can be seen that embodiments described herein improve the user experience by simplifying the modification of a virtual environment by modifying the virtual environment based on non-speech sound detection.

It will be appreciated that the processor 107 may have access to other sources of information about the user 104. For example, in some embodiments the user 104 may appear on a video feed. In this case the processor 107 may determine the modification based partly on sound recognition and partly on the other sources of information. For example, if the processor 107 recognizes that the user is laughing, it may be possible to check the video feed for visual confirmation of a laughing motion of the user 104 before making a modification to the virtual environment based on detecting laughter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computing device for modifying a virtual environment based on a detected sound, the computing device comprising:
a microphone;
a display configured to display a virtual environment to a user;
and
a processor;
wherein the processor is configured to:
receive, via the microphone, audio data of audio in a monitored environment;
use the audio data to determine the occurrence of a non-speech target sound in the monitored environment;
determine a modification of the virtual environment associated with the non-speech target sound; and
control the display to implement the determined modification.

2. The computing device of claim 1 further comprising a user input device, wherein the virtual environment comprises a virtual scene and a user controlled object positioned within the virtual scene, the user controlled object controllable by the user using the user input device.

3. The computing device of claim 2, wherein the determined modification comprises a modification of the virtual scene.

4. The computing device of claim 3, wherein the determined modification comprises a modification of a lighting level of the virtual scene.

5. The computing device of claim 3, wherein the determined modification comprises a modification of the appearance of scenery of the virtual scene.

6. The computing device of claim 3, wherein the determined modification comprises insertion of at least one new virtual object into the virtual scene.

7. The computing device of claim 1, wherein the determined modification comprises a modification of the user controlled object.

8. The computing device of claim 7, wherein the determined modification comprises at least one of: a modification of an expression of the user controlled object, a modification of a colour of the user controlled object, a visual animation of the user controlled object, and adding a new object to the user controlled object.

9. The computing device of claim 1, wherein the user controlled object is an avatar.

10. The computing device of claim 1, wherein the processor is further configured to generate metadata relating to the non-speech target sound, and determine the modification based on the metadata.

11. The computing device of claim 10, wherein the metadata comprises labels describing at least one of an intensity of the non-speech target sound, a temporal pattern of the non-speech target sound, a count of a number of occurrences of the non-speech target sound, and a duration of the non-speech target sound.

12. The computing device of claim 10, wherein the metadata comprises quantitative measurements of an intensity of the non-speech target sound, a temporal pattern of the non-speech target sound, a count of a number of occurrences of the non-speech target sound, and a duration of the non-speech target sound.

13. The computing device of claim 1, wherein the at least one target sound conveys semantic information.

14. The computing device of claim 1, wherein the virtual environment is an electronic video game environment.

15. The computing device of claim 1, wherein the virtual environment is part of a metaverse virtual world.

16. The computing device of claim 1, wherein the display is a virtual reality display or an augmented reality device.

17. The computing device of claim 1, wherein the computing device further comprises a memory storing one or more sound models, wherein the sound models correspond to one or more non-speech target sounds; and
the processor is configured to determine the occurrence of a non-speech target sound in the monitored environment by comparing the audio data to said one or more sound models to recognize a non-speech target sound of said one or more non-speech target sounds in the monitored environment.

18. The computing device of claim 17, wherein each of the one or more sound models correspond to a respective non-speech target sound.

19. A method of modifying a virtual environment based on a detected sound, the method implemented on a processor contained in a computing device and comprising:
displaying a virtual environment to a user using a display;
receiving audio data of audio in a monitored environment using a microphone;
using the audio data to determine the occurrence of a non-speech target sound in the monitored environment;
determining a modification of the virtual environment associated with the non-speech target sound; and
controlling the display to implement the determined modification.

20. A non-transitory computer-readable storage medium comprising instructions which, when executed by a processor of a computing device, cause the computing device to perform a method comprising:
displaying a virtual environment to a user using a display;
receiving audio data of audio in a monitored environment using a microphone;
using the audio data to determine the occurrence of a non-speech target sound in the monitored environment;
determining a modification of the virtual environment associated with the non-speech target sound; and
controlling the display to implement the determined modification.
